(19) United States
(12) Patent Application Publication
(10) Pub. No.: US 2015/0283758 A1
(43) Pub. Date: Oct. 8, 2015

(54) METHOD OF MAKING THREE-DIMENSIONAL OBJECTS USING CRYSTALLINE AND AMORPHOUS COMPOUNDS

(71) Applicant: Xerox Corporation, Norwalk, CT (US)

(72) Inventors: Adela Goredema, Mississauga (CA); Jennifer L. Belelie, Oakville (CA); Marcel P. Breton, Mississauga (CA); Barkev Keoshkerian, Thornhill (CA)

(73) Assignee: Xerox Corporation, Norwalk, CT (US)

(21) Appl. No.: 14/247,376

(22) Filed: Apr. 8, 2014

(51) Int. Cl. B29C 67/00

(52) U.S. Cl. CPC B29C 67/0055; B33Y 10/00; B33Y 30/00; B29L 2009/00

(57) ABSTRACT

A method for forming a three-dimensional object using layer by layer formation of the object through application of stereolithography. More specifically, the formation of a three-dimensional object using a three-dimensional printer based on thermal stereolithography and phase change materials comprising a combination of crystalline and amorphous compounds.

### BACKGROUND

The present embodiments relate generally to the formation of a three-dimensional object using layer by layer formation of the object through application of stereolithography. More specifically, the present embodiments relate to the formation of a three-dimensional object using a three-dimensional printer. To form the three-dimensional object, certain materials are employed which are characterized by being solid at room temperature and molten or flowable at an elevated temperature at which the molten material is applied to form layers. Subsequent deposition of layers upon the first layer generates a three-dimensional object. The material is made flowable upon the application of thermal radiation. Thus, in such embodiments, the three-dimensional printer uses thermal stereolithography to form the three-dimensional objects. In the present embodiments, the materials comprise a combination of crystalline and amorphous materials, like those described in U.S. Pat. No. 8,506,040, which is hereby incorporated by reference in its entirety.

Stereolithography is a model building technique that builds three-dimensional objects in layers, as described in U.S. Pat. Nos. 4,575,330 and 4,929,402, which are hereby incorporated by reference in their entireties.

Generally, in stereolithography, a three-dimensional object is formed layer by layer in a stepwise fashion out of a material capable of physical transformation upon exposure to synergistic stimulation. For example, in one embodiment of stereolithography, layers of untransformed material such as liquid photopolymer are successively formed at the working surface of an amount of the liquid photopolymer contained in a container. The untransformed layers are successively formed over previously-transformed material. The untransformed layers are selectively exposed to synergistic stimulation such as UV radiation, or the like, wherein such layers form object layers. After formation into the object layers, the untransformed layers typically adhere to the previously-formed layers through the natural adhesive properties of the photopolymer upon solidification.

More recently, three-dimensional printing to form three-dimensional objects is becoming more popular. Such printing methods can be used to form anything from small parts for household appliances and toys to components for computers and automobiles. In recent years, three-dimensional printers are being used more frequently in both homes and offices. Current three-dimensional printers operate based on thermal stereolithography. The settings that these printers are used within require that the printing materials be non-reactive and non-toxic.

A persistent problem that exists in relation to thermal stereolithography and, in particular, as it relates to three-dimensional printing is finding suitable materials that are capable of being dispensed from the dispensers currently used in such systems (such as an ink jet print head), and which are also capable of forming three-dimensional objects with suitable robustness and accuracy in formation. For example, in thermal stereolithography, there is the need to quickly solidify the flowable material after its dispensed. The time needed for heat to be removed and allow sufficient material solidification limits the ability to lay subsequent layers, since newly dispensed material may deform if not cooled sufficiently before the next layer is dispensed. Thus, this phase change property impacts the overall object build time. Other known materials, such as hot melt inks, are either not sufficiently robust, tend to be brittle, exhibit significant layer to layer distortion, have high viscosities, or other properties that make them difficult to handle and dispense from multiorifice ink jet dispensers such as those which may be used in thermal stereolithography.

Accordingly, it is an object of the present embodiments to provide an apparatus of and method for providing robust three-dimensional objects through application of thermal stereolithography. It is a further object to provide a material that can be used with such apparatus and method to form improved three-dimensional objects that are more robust than those formed with prior known materials and compositions.

### SUMMARY

According to embodiments illustrated herein, there is provided a method for forming three-dimensional objects comprising: providing a phase change material, wherein the phase change material comprises a crystalline compound and an amorphous compound; heating the phase change material to a jetting temperature; jetting the phase change material in layers on top of one another, wherein each layer is allowed to cool and/or solidify before jetting a subsequent layer; and forming a three-dimensional object from the cool and/or solidified layers.

In particular, the present embodiments provide a method for forming three-dimensional objects comprising: providing a phase change material, wherein the phase change material comprises a crystalline compound and an amorphous compound; heating the phase change material to a jetting temperature; jetting the phase change material to form a first layer; allowing the first layer to cool and/or solidify; and selectively jetting subsequent layers onto the first layer, either partially or entirely, wherein each layer is allowed to cool and/or solidify before jetting the next layer; and forming a three-dimensional object from the cool and/or solidified layers.

In further embodiments, there is provided a system for forming three-dimensional objects comprising: a phase change material, wherein the phase change material comprises a crystalline compound and an amorphous compound; and an ink jet printer further comprising a reservoir for holding the phase change material, a heating element for heating the phase change material to a jetting temperature, and a printhead for jetting the phase change material in successive layers to form a three-dimensional object.

### BRIEF DESCRIPTION OF THE DRAWINGS

For a better understanding of the present embodiments, reference may be made to the accompanying figures.

FIG. 1 provides the rheology profile for three phase change materials made according to the present embodiments.

### DETAILED DESCRIPTION

In the following description, it is understood that other embodiments may be utilized and structural and operational changes may be made without departure from the scope of the present embodiments disclosed herein.

Three-dimensional printing to generate three-dimensional objects is gaining popularity across many markets, and the possibilities for its use continue to expand as the technology improves. The present embodiments provide an apparatus of and method for providing three-dimensional objects through application of stereolithography, using solid materials which are made molten or flowable upon the application of thermal radiation such as heat. The present embodiments further provide a unique material comprising a crystalline compound and an amorphous compound which is solid at room temperature and molten at an elevated temperature and which provides for improved robustness as compared to the wax-based materials typically used in three-dimensional printing. As used herein, room temperature is defined as from about 20 to about 27° C.

It has been discovered that using a mixture of crystalline and amorphous compounds in phase change materials used in three-dimensional printing based on thermal stereolithography provides robust objects. Using this approach is surprising, however, due to the known properties of crystalline or amorphous materials. For crystalline materials, small molecules generally tend to crystallize when solidifying and low molecular weight organic solids are generally crystals. While crystalline materials are generally harder and more resistant, such materials are also much more brittle, so that printed matter made using a mainly crystalline ink composition is fairly sensitive to damage. For amorphous materials, high molecular weight amorphous materials, such as polymers, become viscous and sticky liquids at high temperature, but do not show sufficiently low viscosity at high temperatures. As a result, the polymers cannot be jetted at desirable jetting temperature (≦140° C.). In the present embodiments, however, it is discovered that a robust phase change material can be obtained through a blend of crystalline and amorphous compounds.

The present embodiments provide a new type of phase change material which comprises a blend of (1) crystalline and (2) amorphous compounds, generally in a weight ratio of from about 60:40 to about 95:5, respectively. In more specific embodiments, the weight ratio of the crystalline to amorphous compound is from about 65:35 to about 95:5, or is from about 70:30 to about 90:10. In one embodiment, the weight ratio is 70:30 for the crystalline and amorphous compounds, respectively. In another embodiment, the weight ratio is 80:20 for the crystalline and amorphous compounds, respectively.

Each component imparts specific properties to the phase change materials, and the blend of the components provides materials that exhibit excellent robustness. The crystalline compound in the phase change formulation drives the phase change through rapid crystallization on cooling. The crystalline compound also sets up the structure of the final printed object and creates a hard three-dimensional object by reducing the tackiness of the amorphous compound. The crystalline compounds exhibit crystallization, relatively low viscosity (≦12 centipoise (cps), or from about 0.5 to about 10 cps, or from about 1 to about 10 cps) at about 140° C. and high viscosity (>10⁶ cps) at room temperature. Because the crystalline compounds dictate the phase change of the material, rapid crystallization is required to facilitate the ability to print the next layer faster. By differential scanning calorimetry (DSC) (10° C./min from −50 to 200 to −50° C.), desirable crystalline compounds show sharp crystallization and melting peaks, and the ΔT between them is less than 55° C. The melting point must be below 150° C., to provide jetting at lower temperature, or preferably below from about 145 to about 140° C. The melting point is preferably above 65° C. to provide structural integrity after standing at temperatures up to 65° C., or more preferably above about 66° C. or above about 67° C. Examples of suitable crystalline compounds are illustrated in Table 1.

TABLE 1
Crystalline Compounds

| Compound | | |
|---|---|---|
| No. | Structure | Reference |
| 1 | 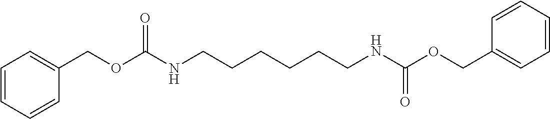 [SMILES: O=C(NCCCCCCNC(=O)OCc1ccccc1)OCc1ccccc1] | U.S. patent application Ser. No. 13/196,227 to Goredema et al |
| | Dibenzyl hexane-1,6-diyldicarbamate | |
| 2 | 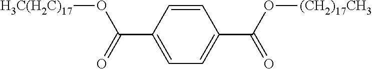 | U.S. patent application Ser. No. 13/681,106 to Goredema et al |
| | Distearyl Terepthalate (DST) | |
| 3 | 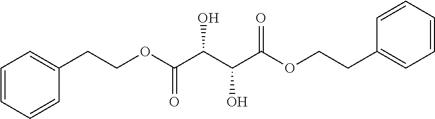 [SMILES: O=C(OCCc1ccccc1)[C@H](O)[C@@H](O)C(=O)OCCc1ccccc1] | U.S. patent application Ser. No. 13/095,715 to Morimitsu et al |
| | Di-Phenylethyl-(L)-Tartarate | |

The amorphous compounds provide tackiness and impart robustness to the printed three-dimensional object. In the present embodiments, desirable amorphous compounds have relatively low viscosity (<10² cps, or from about 1 to about 100 cps, or from about 5 to about 95 cps) at about 140° C., but very high viscosity (>10⁶ cps) at room temperature. The low viscosity at 140° C. provides wide formulation latitude while the high viscosity at room temperature imparts robustness. The amorphous compounds have T_{g}s (glass transition temperatures) but do not exhibit crystallization and melting peaks by DSC (10° C./min from −50 to 200 to −50° C.). The T_{g} values are typically from about 10 to about 50° C., or from about 10 to about 40° C., or from about 10 to about 35° C., to impart the desired toughness and flexibility to the phase change materials. The selected amorphous compounds have low molecular weights, such as less than 1000 g/mol, or from about 100 to about 1000 g/mol, or from about 200 to about 1000 g/mol, or from about 300 to about 1000 g/mol. Higher molecular weight amorphous compounds such as polymers become viscous and sticky liquids at high temperatures, but have viscosities that are too high to be jettable with printheads at desirable temperatures. Examples of suitable amorphous compounds are illustrated in Table 2.

TABLE 2
Amorphous Compounds

| Compound | | |
|---|---|---|
| No. | Structure | Reference |
| 1 | 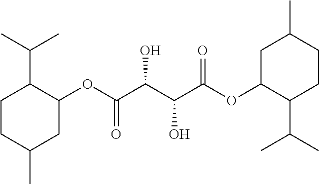 [SMILES: CC1CCC(C(C)C)C(OC(=O)[C@H](O)[C@@H](O)C(=O)OC2CC(C)CCC2C(C)C)C1] | U.S. Pat. No. 8,500,896 to Morimitsu et al |
| | and Isomers | |
| | Dimenthol Tartarate DMT | |
| 2 | 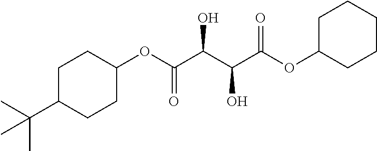 [SMILES: CC(C)(C)C1CCC(OC(=O)[C@@H](O)[C@H](O)C(=O)OC2CCCCC2)CC1] | in U.S. Pat. No. 8,500,896 to Morimitsu et al |
| | and mixtures | |
| | TBCT | |
| | (t-Butylcyclohexyl-Cyclohexyl Tartrate) | |
| 3 | 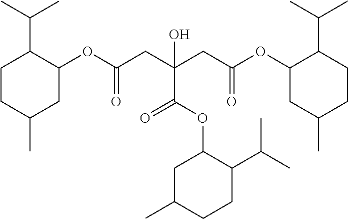 [SMILES: CC1CCC(C(C)C)C(OC(=O)CC(O)(CC(=O)OC2CC(C)CCC2C(C)C)C(=O)OC2CC(C)CCC2C(C)C)C1] | U.S. patent application Ser. No. 13/095,795 to Morimitsu et al |
| | Trimenthol | |
| | Citrate | |

In embodiments, the carriers for the phase change materials may have melting points of from about 65° C. to about 150° C., for example from about 70° C. to about 140° C., from about 75° C. to about 135° C., from about 80° C. to about 130° C., or from about 85° C. to about 125° C. as determined by, for example, by differential scanning calorimetry at a rate of 10° C./min. In embodiments, the resulting phase change material has a melting point of from about 65 to about 140° C., or from about 65 to about 135° C., or from about 70 to about 130° C. In embodiments, the resulting phase change material has a crystallization point of from about 65 to about 130° C., or from about 66 to about 125° C., or from about 66 to about 120° C. In further embodiments, the resulting phase change has a viscosity of from about 1 to about 15 cps, or from about 2 to about 14 cps, or from about 3 to about 13 cps at about 140° C. At room temperature, the resulting phase change material is a robust solid having a viscosity of about ≧10⁶ cps. The phase change materials of the present embodiments provide quick solidification upon cooling. In embodiments, the phase change materials reach a solid form having a viscosity of greater than 1×10⁶ cps within a time period of from about 5 to about 15 seconds or from about 5 to about 8 seconds upon cooling. As used herein, “cooling” means the removal of heat and return to ambient temperature.

The phase change materials of the present embodiments may further include conventional additives to take advantage of the known functionality associated with such conventional additives. Such additives may include, for example, at least one antioxidant, defoamer, slip and leveling agents, clarifier, viscosity modifier, adhesive, plasticizer and the like.

The phase change may optionally contain antioxidants to protect the formed objects from oxidation and also may protect the phase change material components from oxidation while existing as a heated and melted material in the printer reservoir. Examples of suitable antioxidants include N,N′-hexamethylene bis(3,5-di-tert-butyl-4-hydroxy hydrocinnamamide) (IRGANOX 1098, available from BASF); 2,2-bis(4-(2-(3,5-di-tert-butyl-4-hydroxyhydrocinnamoyloxy))ethoxyphenyl)propane (TOPANOL-205, available from Vertellus); tris(4-tert-butyl-3-hydroxy-2,6-dimethyl benzyl)isocyanurate (Aldrich); 2,2′-ethylidene bis(4,6-di-tert-butylphenyl)fluoro phosphonite (ETHANOX-398, available from Albermarle Corporation); tetrakis(2,4-di-tert-butylphenyl)-4,4′-biphenyl diphosphonite (Aldrich); pentaerythritol tetrastearate (TCI America); tributylammonium hypophosphite (Aldrich); 2,6-di-tert-butyl-4-methoxyphenol (Aldrich); 2,4-di-tert-butyl-6-(4-methoxybenzyl)phenol (Aldrich); 4-bromo-2,6-dimethylphenol (Aldrich); 4-bromo-3,5-didimethylphenol (Aldrich); 4-bromo-2-nitrophenol (Aldrich); 4-(diethyl aminomethyl)-2,5-dimethylphenol (Aldrich); 3-dimethylaminophenol (Aldrich); 2-amino-4-tert-amylphenol (Aldrich); 2,6-bis(hydroxymethyl)-p-cresol (Aldrich); 2,2′-methylenediphenol (Aldrich); 5-(diethylamino)-2-nitrosophenol (Aldrich); 2,6-dichloro-4-fluorophenol (Aldrich); 2,6-dibromo fluoro phenol (Aldrich); α-trifluoro-o-cresol (Aldrich); 2-bromo-4-fluorophenol (Aldrich); 4-fluorophenol (Aldrich); 4-chlorophenyl-2-chloro-1,1,2-tri-fluoroethyl sulfone (Aldrich); 3,4-difluoro phenylacetic acid (Adrich); 3-fluorophenylacetic acid (Aldrich); 3,5-difluoro phenylacetic acid (Aldrich); 2-fluorophenylacetic acid (Aldrich); 2,5-bis(trifluoromethyl)benzoic acid (Aldrich); ethyl-2-(4-(4-(trifluoromethyl)phenoxy)phenoxy)propionate (Aldrich); tetrakis (2,4-di-tert-butyl phenyl)-4,4′-biphenyl diphosphonite (Aldrich); 4-tert-amyl phenol (Aldrich); 3-(2H-benzotriazol-2-yl)-4-hydroxy phenethylalcohol (Aldrich); NAUGARD 76, NAUGARD 445, NAUGARD 512, and NAUGARD 524 (manufactured by Chemtura Corporation); and the like, as well as mixtures thereof. The antioxidant, when present, may be present in the phase change material in any desired or effective amount, such as from about 0.25 percent to about 10 percent by weight of the phase change material or from about 1 percent to about 5 percent by weight of the phase change material.

In embodiments, the phase change materials described herein also include a colorant. The phase change material may optionally contain colorants such as dyes or pigments. The colorants can be either from the cyan, magenta, yellow, black (CMYK) set or from spot colors obtained from custom color dyes or pigments or mixtures of pigments. Dye-based colorants are miscible with the base composition, which comprises the crystalline and amorphous compounds and any other additives.

Any desired or effective colorant can be employed in the phase change materials, including dyes, pigments, mixtures thereof, and the like, provided that the colorant can be dissolved or dispersed in the carrier and is compatible with the other components used in the phase change materials. The phase change materials can be used in combination with conventional phase change ink colorant materials, such as Color Index (C.I.) Solvent Dyes, Disperse Dyes, modified Acid and Direct Dyes, Basic Dyes, Sulphur Dyes, Vat Dyes, and the like. Examples of suitable dyes include Neozapon Red 492 (BASF); Orasol Red G (Pylam Products); Direct Brilliant Pink B (Oriental Giant Dyes); Direct Red 3BL (Classic Dyestuffs); Supranol Brilliant Red 3BW (Bayer AG); Lemon Yellow 6G (United Chemie); Light Fast Yellow 3G (Shaanxi); Aizen Spilon Yellow C-GNH (Hodogaya Chemical); Bemachrome Yellow GD Sub (Classic Dyestuffs); Cartasol Brilliant Yellow 4GF (Clariant); Cibanone Yellow 2G (Classic Dyestuffs); Orasol Black RLI (BASF); Orasol Black CN (Pylam Products); Savinyl Black RLSN (Clariant); Pyrazol Black BG (Clariant); Morfast Black 101 (Rohm & Haas); Diaazol Black RN (ICI); Thermoplast Blue 670 (BASF); Orasol Blue GN (Pylam Products); Savinyl Blue GLS (Clariant); Luxol Fast Blue MBSN (Pylam Products); Sevron Blue 5GMF (Classic Dyestuffs); Basacid Blue 750 (BASF); Keyplast Blue (Keystone Aniline Corporation); Neozapon Black X51 (BASF); Classic Solvent Black 7 (Classic Dyestuffs); Sudan Blue 670 (C.I. 61554) (BASF); Sudan Yellow 146 (C.I. 12700) (BASF); Sudan Red 462 (C.I. 26050) (BASF); C.I. Disperse Yellow 238; Neptune Red Base NB543 (BASF, C.I. Solvent Red 49); Neopen Blue FF-4012 (BASF); Fatsol Black BR (C.I. Solvent Black 35) (Chemische Fabriek Triade BV); Morton Morplas Magenta 36 (C.I. Solvent Red 172); metal phthalocyanine colorants such as those disclosed in U.S. Pat. No. 6,221,137, the disclosure of which is totally incorporated herein by reference, and the like. Polymeric dyes can also be used, such as those disclosed in, for example, U.S. Pat. No. 5,621,022 and U.S. Pat. No. 5,231,135, the disclosures of each of which are herein entirely incorporated herein by reference, and commercially available from, for example, Milliken & Company as Milliken Ink Yellow 869, Milliken Ink Blue 92, Milliken Ink Red 357, Milliken Ink Yellow 1800, Milliken Ink Black 8915-67, uncut Reactint Orange X-38, uncut Reactint Blue X-17, Solvent Yellow 162, Acid Red 52, Solvent Blue 44, and uncut Reactint Violet X-80.

Pigments are also suitable colorants for the phase change materials. Examples of suitable pigments include PALIOGEN Violet 5100 (BASF); PALIOGEN Violet 5890 (BASF); HELIOGEN Green L8730 (BASF); LITHOL Scarlet D3700 (BASF); SUNFAST Blue 15:4 (Sun Chemical); Hostaperm Blue B2G-D (Clariant); Hostaperm Blue B4G (Clariant); Permanent Red P-F7RK; Hostaperm Violet BL (Clariant); LITHOL Scarlet 4440 (BASF); Bon Red C (Dominion Color Company); ORACET Pink RF (BASF); PALIOGEN Red 3871 K (BASF); SUNFAST Blue 15:3 (Sun Chemical); PALIOGEN Red 3340 (BASF); SUNFAST Carbazole Violet 23 (Sun Chemical); LITHOL Fast Scarlet L4300 (BASF); SUNBRITE Yellow 17 (Sun Chemical); HELIOGEN Blue L6900, L7020 (BASF); SUNBRITE Yellow 74 (Sun Chemical); SPECTRA PAC C Orange 16 (Sun Chemical); HELIOGEN Blue K6902, K6910 (BASF); SUNFAST Magenta 122 (Sun Chemical); HELIOGEN Blue D6840, D7080 (BASF); Sudan Blue OS (BASF); NEOPEN Blue FF4012 (BASF); PV Fast Blue B2GO1 (Clariant); IRGALITE Blue GLO (BASF); PALIOGEN Blue 6470 (BASF); Sudan Orange G (Aldrich); Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Ink Jet Yellow 4G VP2532 (Clariant); Toner Yellow HG (Clariant); Lumogen Yellow D0790 (BASF); Suco-Yellow L1250 (BASF); Suco-Yellow D1355 (BASF); Suco Fast Yellow D1355, D1351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT); PALIOGEN Black L0084 (BASF); Pigment Black K801 (BASF); and carbon blacks such as REGAL ^{330TM} (Cabot), Nipex 150 (Evonik) Carbon Black 5250 and Carbon Black 5750 (Columbia Chemical), and the like, as well as mixtures thereof.

Pigment dispersions in the composition base may be stabilized by synergists and dispersants. Generally, suitable pigments may be organic materials or inorganic. Magnetic material-based pigments are also suitable. Magnetic pigments include magnetic nanoparticles, such as for example, ferromagnetic nanoparticles.

Also suitable are the colorants disclosed in U.S. Pat. No. 6,472,523, U.S. Pat. No. 6,726,755, U.S. Pat. No. 6,476,219, U.S. Pat. No. 6,576,747, U.S. Pat. No. 6,713,614, U.S. Pat. No. 6,663,703, U.S. Pat. No. 6,755,902, U.S. Pat. No. 6,590,082, U.S. Pat. No. 6,696,552, U.S. Pat. No. 6,576,748, U.S. Pat. No. 6,646,111, U.S. Pat. No. 6,673,139, U.S. Pat. No. 6,958,406, U.S. Pat. No. 6,821,327, U.S. Pat. No. 7,053,227, U.S. Pat. No. 7,381,831 and U.S. Pat. No. 7,427,323, the disclosures of each of which are incorporated herein by reference in their entirety.

In embodiments, solvent dyes are employed. An example of a solvent dye suitable for use herein may include spirit soluble dyes because of their compatibility with the carriers disclosed herein. Examples of suitable spirit solvent dyes include Neozapon Red 492 (BASF); Orasol Red G (Pylam Products); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow 5RA EX (Classic Dyestuffs); Orasol Black RLI (BASF); Orasol Blue GN (Pylam Products); Savinyl Black RLS (Clariant); Morfast Black 101 (Rohm and Haas); Thermoplast Blue 670 (BASF); Savinyl Blue GLS (Sandoz); Luxol Fast Blue MBSN (Pylam); Sevron Blue 5GMF (Classic Dyestuffs); Basacid Blue 750 (BASF); Keyplast Blue (Keystone Aniline Corporation); Neozapon Black X51 (C.I. Solvent Black, C.I. 12195) (BASF); Sudan Blue 670 (C.I. 61554) (BASF); Sudan Yellow 146 (C.I. 12700) (BASF); Sudan Red 462 (C.I. 260501) (BASF), mixtures thereof and the like.

The colorant may be present in the phase change material in any desired or effective amount to obtain the desired color or hue such as, for example, at least from about 0.1 percent by weight of the phase change material to about 50 percent by weight of the phase change material, at least from about 0.2 percent by weight of the phase change material to about 20 percent by weight of the phase change material, and at least from about 0.5 percent by weight of the phase change material to about 10 percent by weight of the phase change material.

The phase change material can be prepared by any desired or suitable method. For example, each of the components of the phase change material can be mixed together, followed by heating, the mixture to at least its melting point, for example from about 60° C. to about 150° C., 80° C. to about 145° C. and 85° C. to about 140° C. The colorant may be added before the base ingredients have been heated or after the base ingredients have been heated. When pigments are the selected colorants, the molten mixture may be subjected to grinding in an attritor or media mill apparatus to effect dispersion of the pigment in the carrier. The heated mixture is then stirred for about 5 seconds to about 30 minutes or more, to obtain a substantially homogeneous, uniform melt, followed by cooling the phase change material to ambient temperature (typically from about 20° C. to about 25° C.). The phase change materials are solid at ambient temperature.

The phase change materials of the present embodiments employ thermal stereolithography to form three-dimensional objects. The method may employ an ink jet printhead. In the present embodiments, the method comprises providing a phase change material as described herein. The phase change material is heated to a temperature which melts the phase change material to a liquid such that it is jettable or having a viscosity of from about 1 to about 15 cps. In embodiments, the jetting temperature is at least 140° C., or from about 110 to about 137, or from about 110 to about 135° C. Once the phase change material is jettable, the method selectively jets the phase change material in layers. For example, the phase change material is jetted to form a first layer. The first layer may be formed on a substrate. The first layer is allowed to cool and solidify to at least 5° C. below the material crystallization temperature. In embodiments, the jetted layer is cooled to from about 115 to about 75° C. before jetting the subsequent layer. As described above, the phase change material reaches a solid form having a viscosity of greater than 1×10⁶ cps within a time period of from about 1 to about 10 seconds or from about 1 to about 8 seconds upon cooling. Once solidified, subsequent layers are disposed onto the first layer, allowing each layer to cool and solidify before jetting the next layer, thus forming the three-dimensional object. In forming non-planar layers, a support material may also be used to fill in the gaps as the non-planar layers are formed so as to provide support to the layers as they are being formed. The support material is subsequently removed from the end structure at the end of the process. In embodiments, the support material may comprise materials that have a melting point at least 20 to 30° C. lower than the phase change material melting point. Examples of suitable support materials include stearic acid, stearyl alcohol, bees wax, Carnuba wax, Kester wax K-82H, Kester wax K-60P, Kester wax K-82P, Kester wax K-72 and any waxes with a melting point below 110° C.

The phase change materials described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

Preparation of the Phase Change Material

Amorphous and crystalline materials were synthesized according to the sited references. Several phase change materials were formulated by melt mixing amorphous and crystalline compounds and other components, as illustrated in Table 3. The chemical structures are illustrated in Table 1 (crystalline compounds) and Table 2 (amorphous compounds).

To allow efficient jetting, the phase change formulations must be homogeneous in the melt. Therefore, the amorphous and crystalline materials must be miscible when molten and the crystalline compound must not phase separate upon standing at the jetting temperature for long periods of time.

TABLE 3

| | Phase Change Material, wt % | | |
|---|---|---|---|
| | Phase Change | Phase Change | Phase Change |
| Component | Material 1 | Material 2 | Material 3 |
| Dibenzyl hexane- | 76.5 | 76.5 | |
| 1,6- | | | |
| diyldicarbamate | | | |
| Distearyl | | | 76.5 |
| Terepthalate | | | |
| (DST) | | | |
| di-DL-menthyl L- | 3.5 | | |
| tartrate (DMT) | | | |
| (t- | | 10.2 | 19.1 |
| Butylcyclohexyl- | | | |
| Cyclohexyl | | | |
| Tartrate) (TBCT) | | | |
| Pigment | 20 | 13.3 | |
| concentrate (10% | | | |
| B4G, 10% | | | |
| Solsperse 32000, | | | |
| 2% SunFlo SFD- | | | |
| B124) in DMT | | | |
| Hostaperm Blue | | | 2 |
| B4G | | | |
| Amine based | | | 2 |
| dispersant | | | |
| (described in | | | |
| U.S. Pat. No. | | | |
| 7,973,186, | | | |
| incorporated by | | | |
| reference) | | | |
| SunFlo SFD- | | | 0.4 |
| B124 synergist | | | |
| TOTAL | 100 | 100 | 100 |
| Viscosity at | 7.5 | 10.4 | 5.9 |
| 140° C. (cps) | | | |
| Viscosity at | >10⁶ | >10⁶ | >10⁶ |
| 140° C. (cps) | | | |

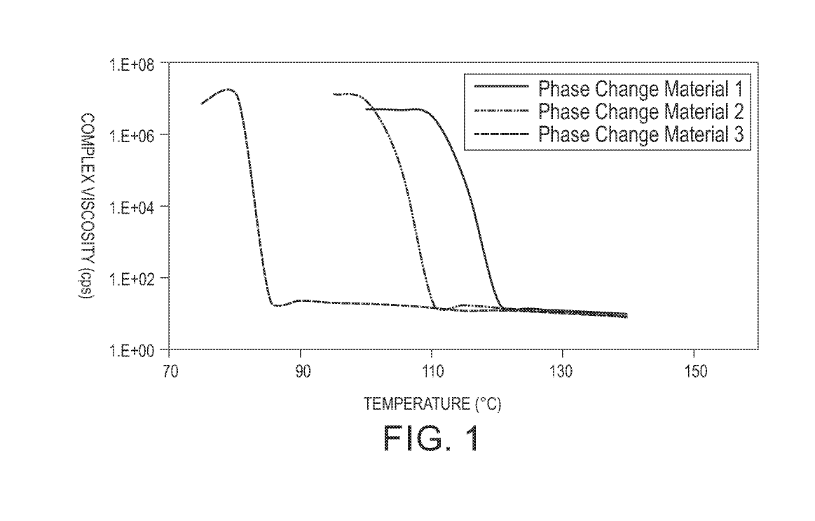

Rheology profiles for the above formulations for the three phase change materials are shown in FIG. 1.

### Example 2

A 2×2 cm block is obtained by jetting phase change material 1 of Example 1 in a randomized pattern (layer to layer) on Xerox Durapaper® paper using a Xerox Phaser® 8400 solid ink printer, jetting at 135° C. Approximately 100 layers are printed, to give a final thickness of approximately 1 mm. Wait time between printing each layer is about 2 seconds. The printhead is moved as the image builds up to maintain a constant distance between the block and the printhead. The block is peeled off from the substrate upon cooling to room temperature, having good structural integrity. The resulting thin block can be handled in a normal manner and showed good resistance to break, demonstrating suitability of the Phase Change Material 1 for a number of applications. It is expected that more complex structures can be printed in the same manner to produce mold or functional objects.

### Example 3

A 2×2 cm block is printed in the same way as in Example 2 except Phase Change Material 2 of Example 1 is used and is jetted at 120° C.

### Example 4

A 2×2 cm block is printed in the same way as in Example 2 except Phase Change Material 3 of Example 1 is used and is jetted at 120° C.

Based on the above properties, the materials of the present embodiments are expected to provide more robust structures than previously achieved through three-dimensional printing.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. A method for forming three-dimensional objects comprising:
providing a phase change material, wherein the phase change material comprises a crystalline compound and an amorphous compound;
heating the phase change material to a jetting temperature;
jetting the phase change material in layers on top of one another, wherein each layer is allowed to cool and/or solidify before jetting a subsequent layer; and
forming a three-dimensional object from the cool and/or solidified layers.

2. The method of claim 1, wherein the crystalline compound has a viscosity of less than 12 cps at a temperature of about 140° C. and a viscosity of greater than 1×10⁶ cps at room temperature.

3. The method of claim 1, wherein the amorphous compound has a viscosity of less than 100 cps at a temperature of about 140° C. and a viscosity of greater than 1×10⁶ cps at room temperature.

4. The method of claim 1, wherein the jetting temperature is from about 110 to about 140° C.

5. The method of claim 1, wherein the jetted layer is cooled to from about 115 to about 75° C. before jetting the subsequent layer.

6. The method of claim 1, wherein cooling and/or solidifying the jetted layer takes from about 1 to about 10 seconds.

7. The method of claim 1, wherein the crystalline compound is selected from the group consisting of dibenzyl hexane-1,6-diyldicarbamate, distearyl terepthalate, Di-Phenylethyl-(L)-Tartarate, stereoisomers thereof and mixtures thereof.

8. The method of claim 1, wherein the amorphous compound is selected from the group consisting of dimenthol tartrate, t-Butylcyclohexyl-Cyclohexyl Tartrate, trimenthol citrate, stereoisomers thereof and mixtures thereof.

9. The method of claim 1, wherein the phase change material further comprises one or more additives.

10. The method of claim 1, wherein the phase change material further comprises a colorant selected from the group consisting of a pigment, dye or mixtures thereof.

11. The method of claim 1, wherein the crystalline and amorphous compounds are blended in a weight ratio of from about 65:35 to about 95:5, respectively.

12. The method of claim 1, wherein the crystalline compound exhibits crystallization (T_{crys}) and melting (Tₘₑₗₜ) peaks according to differential scanning calorimetry and the difference between the peaks (Tₘₑₗₜ−T_{crys}) is less than 55° C.

13. The method of claim 1, wherein the crystalline compound has a melting point of above 65° C.

14. The method of claim 1, wherein the amorphous compound has a molecular weight of less than 1000 g/mol.

15. The method of claim 1, wherein the amorphous compound has a T_{g} value of from about 10 to about 50° C.

16. A method for forming three-dimensional objects comprising:
providing a phase change material, wherein the phase change material comprises a crystalline compound and an amorphous compound;
heating the phase change material to a jetting temperature;
jetting the phase change material to form a first layer;
allowing the first layer to cool and/or solidify; and
selectively jetting subsequent layers onto the first layer, either partially or entirely, wherein each layer is allowed to cool and/or solidify before jetting the next layer; and
forming a three-dimensional object from the cool and/or solidified layers.

17. The method of claim 16, wherein the crystalline and amorphous compounds are blended in a weight ratio of from about 65:35 to about 95:5, respectively.

18. A system for forming three-dimensional objects comprising:
a phase change material, wherein the phase change material comprises a crystalline compound and an amorphous compound; and
an ink jet printer further comprising
a reservoir for holding the phase change material,
a heating element for heating the phase change material to a jetting temperature, and
a printhead for jetting the phase change material in successive layers to form a three-dimensional object.

19. The system of claim 18, wherein the crystalline compound has a viscosity of less than 12 cps at a temperature of about 140° C. and a viscosity of greater than 1×10⁶ cps at room temperature.

20. The system of claim 18, wherein the amorphous compound has a viscosity of less than 100 cps at a temperature of about 140° C. and a viscosity of greater than 1×10⁶ cps at room temperature.
